(19) United States
(12) Patent Application Publication
(10) Pub. No.: US 2006/0255518 A1
(43) Pub. Date: Nov. 16, 2006

(54) Bearing structure for the damped transmission of impact and/or vibratory forces

(75) Inventors: Frank Steffens, Dusseldorf (DE); Roger Hertzfeldt, Grasbrunn (DE)

Correspondence Address: MERCHANT & GOULD PC, P.O. BOX 2903, MINNEAPOLIS, MN, 55402-0903, US

(73) Assignee: Roger HERTZFELDT, Grasbrunn (DE)

(21) Appl. No.: 10/544,561

(22) PCT Filed: Feb. 6, 2003
(86) PCT No.: PCT/EP03/01190

§ 371 Date: May 11, 2006

(51) Int. Cl. F16F 1/44

(52) U.S. Cl. 267/293; 267/141

(57) ABSTRACT

The invention relates to a bearing structure for the damped transmission of impact and/or vibratory forces, in particular for buildings which are subjected to a seismic load, comprising a volume-elastic damping material which is arranged between two parts of a bearing body. According to the invention the first bearing part has essentially the shape of a pot, with a guide sleeve being arranged in the centre of the pot and one or several reinforcing sleeves being arranged between the guide sleeve and the pot inner wall and the damping material filling the spaces between the pot inner wall, reinforcing and guide sleeves at least partially. A second bearing part comprises a bolt which can be displaced inside the guide sleeve, with the bolt being connected with a first fastening plate. A second fastening plate is provided on the outside of the pot in order to anchor the bearing parts at the building. It is also possible to embed the bearing parts, the bolt, and/or the fastening plates in the component to be supported, e. g. to encase them in concrete.

The invention relates to a bearing structure for the damped transmission of impact and/or vibratory forces, in particular for buildings which are subjected to a seismic load, comprising a volume-elastic damping material which is arranged between two parts of a bearing body according to the preamble of Claim 1.

Rubber springs which are responsive to a parallel or torsional thrust but to pressure as well and which are suitable for impact and vibration damping belong to the known state of the art. Such spring elements are used for the damping and absorption of e. g. high frequency structure-born vibrations in the most different fields of mechanics. Commercial rubber springs comprise moulded rubber parts with metallic connecting pieces for fasting and force introduction vulcanised thereon. Rubber as a volume-elastic and incompressible material has a non-linear stress-extension behaviour, with the proportionality between load and shaping being limited in accordance with Hook's law.

Metal/rubber bearings e. g. for compensating thermally induced expansion forces in bridges or other buildings are widely used. Such structures are, however, not suited for the accommodation of seismically caused loads.

A possible strategy for reducing the stress on buildings under seismic load is the so-called earth quake isolation. This term means the decoupling of the resonance vibration time of the building from the excitation frequency of the earth quake. This is done by forming a horizontally soft bearing plane which increases the resonance vibration time of the building. Due to the characteristics of the earth quake excitation, a significant stress reduction of the affected buildings is achieved if the resonance vibration time of the respective system ranges from approx. 3 to 5 seconds.

Because of the employment of standardised bearings, however, the stiffness of the bearing plane may be controlled to a limited extent only. An increase of the resonance vibration time e. g. of bridge systems to the range of 3 to 5 seconds by means of standardised elastomer bearings can seldom be achieved. Known bridge bearings are realised by horizontally soft elastomer bearings together with rigid fastening means. These rigid fastening means are extremely rarely able to accommodate the forces occurring in the case of an earth quake and, moreover, degrade the dynamic behaviour of the building.

Drawbacks of known measures of the earth quake isolation are the occurring relative movements between the components, which increase with a longer natural vibration time of the system. In bridge construction, in particular, the extent of the justifiable movements, primarily in the transverse direction, is very limited.

As to the state of the art, reference is made to the German patent 498 043 which shows an annular spring, though it does not deal with the accommodation of horizontally acting forces, while no forces are transmitted in the vertical direction. FR 2 652 865 A1 pursues a similar approach. In this case, too, a free movement in the z direction is not provided for. Incidentally, the application case which is contemplated in this state of the art is directed to a damping device for wheel suspensions at rail vehicles.

U.S. Pat. No. 2,126,707, too, shows a kind of an annular spring with rubber-elastic damping spaces. The disclosed elliptic shape of the damping body does not address the problem of the free movability in the z direction and the different damping values in the direction of the major and minor axis.

Based on the above, it is therefore the object of the invention to specify an advanced bearing structure as an element in a bearing system for the damped transmission of impact and/or vibratory forces, in particular for buildings which are subjected to a seismic load, with the structure to be selected in such a manner that a simple and optimum adjustment with respect to the vibration behaviour of the building, the maximum extent of the possible movement, the forces to be transmitted and with respect to the desired high damping of the element may be effected.

This object of the invention is solved by a bearing structure according to the characteristics of Claim 1, with the dependent claims comprising at least suitable embodiments and developments.

According to the invention, a first bearing part is essentially formed like a pot, with a guide sleeve being arranged in the pot centre and one or several reinforcing sleeves being arranged between the guide sleeve and the pot inner wall. A volume-elastic damping material at least partially fills the spaces between pot inner wall, reinforcing, and guide sleeves.

A second bearing part comprises a bolt which may be displaced within the guide sleeve, with the bolt being connected with a first fastening plate. A second fastening plate or fastening area is provided on the outside of the pot so that the first and second bearing part may be anchored e. g. between a foundation and the building to be supported.

The reinforcing sleeves are preferably arranged concentrically about the guide sleeve and are at least partially embedded in the damping material.

The reinforcing sleeves are adapted to the cross-sectional shape of the pot. In a pot with an annular shape, the reinforcing sleeves are therefore also annular with correspondingly stepped diameter ratios.

The pot itself may comprise the mentioned circular or annular form but also an elliptic, rectangular, or polygonal cross-section or such a cross-sectional area, respectively.

The top and bottom areas of the pot are open and are provided with a cover in such a manner that the movement of the bolt, on the one hand, but also of the damping material, on the other hand, is not impeded. In other words, the damping material must be able to expand essentially freely upon deformation perpendicularly to the direction of the action of the force.

The damping material is connected with the pot inner wall, the outer wall of the guide sleeve, and/or of the reinforcing sleeves by vulcanisation.

The first or the second fastening plate or fastening area, respectively, is anchored, on the one hand, at the abutment, pillar, or foundation of the component to be supported and, on the other hand, on the component to be supported itself.

The anchoring is effected in such a manner that forces acting horizontally or in the x and y direction, respectively, may be accommodated, while no forces are transmitted vertically, which is realised in that the bolt of the guide sleeve is movably supported clearance-free. Fastening is also possible in such a manner that the fastening plate, the first and/or second bearing part or the bolt, respectively, are embedded e. g. encased in concrete in the component to be supported.

With an elliptic cross-sectional area, too, for example, of the pot and thus of the reinforcing sleeves and the damping material, different damping values may be specified the direction of the ellipse's major and minor axis.

In order to be able to accommodate maximal forces without destruction of the areas vulcanised thereon the damping material in the marginal transition areas between the damping material and the pot inner wall and/or the outer wall of the guide sleeve is formed to be cambered relative to the average thickness distribution in the unloaded condition. This transition area is therefore formed to be continuously rising or with an annular or bead-type gradient, respectively.

In order to further improve the adhesion of the damping material, the reinforcing sleeves are provided with a chamfer at their narrow sides or extend arc-shaped or have a correspondingly shaped curvature, respectively.

With a rectangular cross-sectional area of the pot, similar to an elliptic configuration, various damping and stiffness ratios in the direction of the respective edges of the rectangle can be set.

The damping material is a natural or synthetic high polymer, with the pot, the reinforcing and the guide sleeves consisting of metal, in particular, of steel.

The metallic surface areas to be connected by vulcanisation preferably have a roughened structure.

The load bearing capacity and the deformation capability of the bearing structure essentially depends on the diameter and shape of the outer ring, i. e. of the pot, the diameter and shape of the guide bolt and the associated sleeve, and the number, distribution, height, and thickness of the elastomer or damping material layers, respectively. The deformation behaviour of the entire arrangement may be set by the elastomer material itself, while the respective elastomer layers may also be formed from different materials with different properties. Another variable for designing the properties of the bearing structure is the possible choice between vulcanised and non vulcanised embodiment with respect to the connection between damping material and the metallic parts of the arrangement.

The strength, thickness, and reinforcements of the metallic parts are selected in accordance with their potential maximum load. The stress on the elastomer material may be reduced by structural detail solutions, i. e. by a variable upper and/or lower elastomer covering of the reinforcing sleeves themselves, but also by a design of the connection site between elastomer and pot inner wall as well as elastomer and outer surface of the guide sleeve, respectively, in a corresponding stress-reducing shape.

An inventive use of the bearing structure is the purpose of elastically transmitting horizontal forces, i. e. forces in the x and y direction, in the bearing of buildings.

As a special field of application, the protection of buildings, e. g. bridges, against earth quakes is to be mentioned. It is advantageous that the element preferably transmits forces in the x/y plane only, i. e. perpendicularly to the reinforcing sleeves. Displacements of the neighbouring components perpendicularly to the plane of the element, i. e. in the z direction namely parallel to the reinforcing sleeves, are enabled in a nearly force-free manner.

Contrary to known horizontal fastenings, the given elasticity of the damping material or the elastomer layers, respectively, enables horizontal movements to take place. This causes a continuous increase of the restoring forces. The stiffness of the bearing structure increases with the extent of deformation, i. e. a progressive stiffness is given. With the employment of the inventive bearing structure, damping upon dynamic stress is obtained in the desired manner. The mentioned parameters allow a wide dimensioning of the bearing structure, wherein the overall damping behaviour can be influenced in a controlled manner by varying the material properties of the elastomer.

With the employment of the bearing structure a nearly force-free bearing in a preferred direction with small building movements in the sense of a floating bearing of the building is possible, whereby forced stresses are reduced. With larger building movements, the restoring forces increase progressively and an energy dissipation by the damping behaviour of the elastomer itself takes place, which results in reduced stresses of the building upon a dynamic load, e. g. an earth quake.

The simple dimensioning of the bearing structure relative to the desired force-deformation behaviour has created the possibility to adjust the bearing of a building to the requirements or influences in a controlled manner. This adjustment may be achieved with respect to the vibration behaviour of the building, the maximum extent of the possible movements, the forces to be transmitted, and the damping of the bearing structure. Contrary to conventional bearings, a different damping behaviour in the longitudinal and transverse direction or in the x and y direction, respectively, may be set by the selection of different cross-sectional shapes. This makes the extent of a possible maximum displacement in a certain direction controllable.

For the manufacture of the inventive bearing structure a novel approach is pursued. This technology is characterised in that a rubber-elastic material is first wrapped around the guide sleeve. A first reinforcing sleeve is mounted over the object thus obtained. Subsequently, the rubber compound is wrapped around another time and so forth. This pre-manufactured part is then put into a mould which simultaneously represents the outer wall or the bearing part, respectively. The mould bottom and the mould cover are arched inwardly in order to assist in forming the transition areas of the rubber compound to the metallic parts. The actual vulcanisation process, i. e. the joining of the wrapped layer to one another and to the reinforcing sleeves or the bearing part, respectively, and to the side of the guide sleeve facing towards the rubber material, takes then place by means of a thermal or pressure and thermal treatment, respectively. By the number and the kind of the wrapped layers and thus the wrapped thickness bearing structures of different dimensions, in particular of different diameters, can be realised in a simple manner and at low cost. Compared to the state of the art which is based on cut out annuli which are mounted over the sleeves, interfering air inclusions are avoided.

The invention will be explained in more detail in the following by means of an embodiment as well as with reference to the figures; in which:

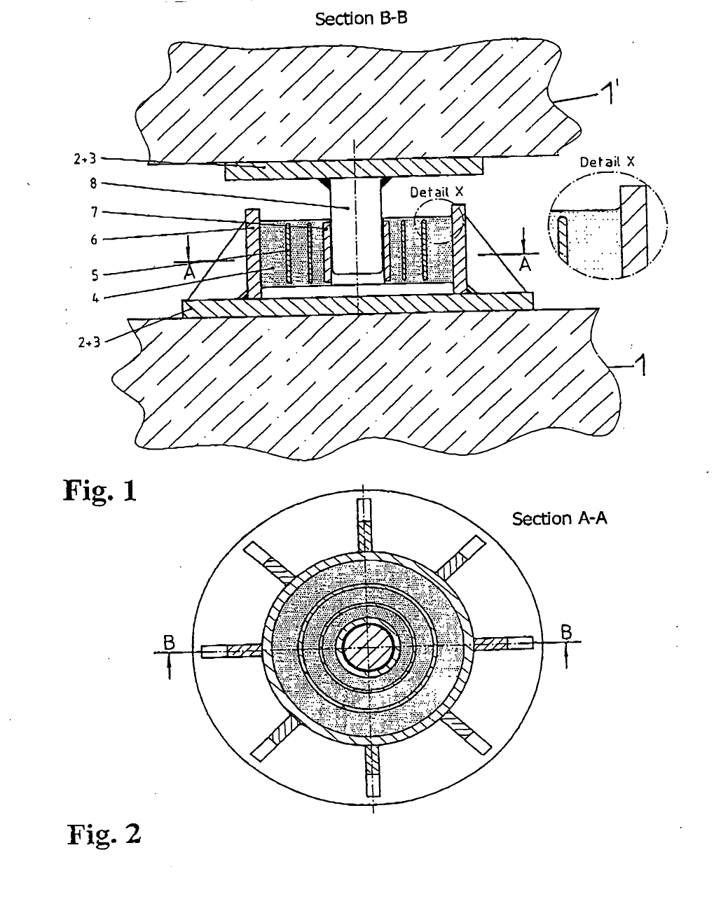

FIG. 1 is a sectional illustration of the bearing structure according to an embodiment;

FIG. 2 is another sectional illustration along the line A-A according to FIG. 1; and

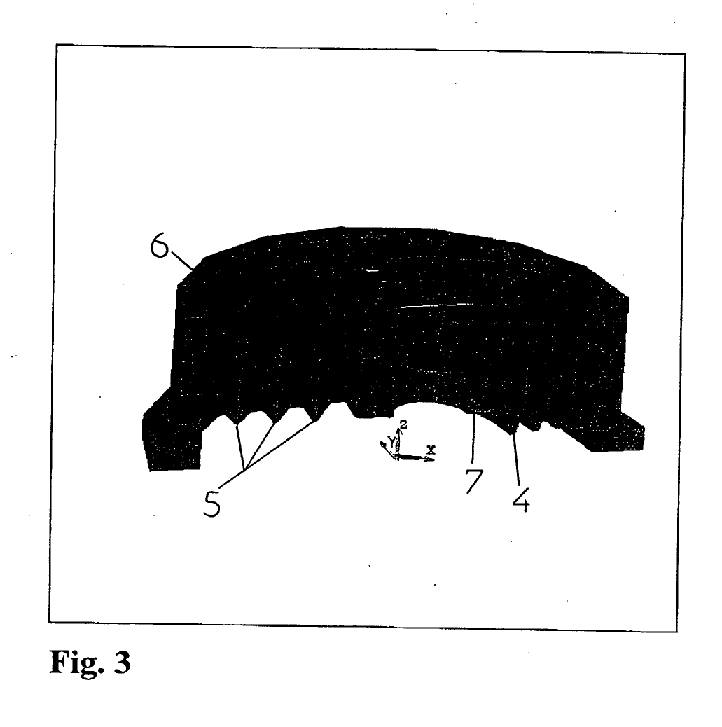

FIG. 3 is a principal illustration in a partially perspective view of the bearing structure when loaded in the x direction.

The bearing structure in accordance with the following description is anchored e. g. between a foundation 1 and a component 1′ to be supported, e. g. a bridge, in a suitable manner via fastening areas 2 and 3.

Generally, there is the possibility that the first pot-shaped bearing part 6 is secured at the foundation 1 but also at the component 1′ to be supported.

The first pot-shaped bearing part 6 has a guide sleeve 7 in its centre, with one or several reinforcing sleeves 5 being arranged between the guide sleeve 7 and the inner wall of the first bearing part 6. A damping material 4 fills the spaces at least partially between the pot inner wall as well as the reinforcing sleeves 5. and the guide sleeve 7.

The second bearing part comprises a bolt 8 which is displaceable in the guide sleeve 7, with the bolt 8 being connected with a corresponding fastening plate 2; 3.

In the illustrated example, the reinforcing sleeves 5 are arranged concentrically about the guide sleeve 7 and embedded in the damping material 4. The reinforcing sleeves 5 are adapted to the cross-sectional shape of the pot-shaped first bearing part 6. The reinforcing sleeves 5 thus have, for example, an annular shape similar to the shape of the pot.

There is also the possibility, though not shown in the figures, that the pot has an elliptic, rectangular, or polygonal cross-sectional area. The upper and lower surfaces of the pot are designed in such a manner that the damping material 4 as can be seen in the right-hand portion of FIG. 3, may expand freely upwards and downwards in the x direction upon a corresponding load.

The damping material 4 is connected with the respective, preferably metallic surfaces of the pot, the reinforcing sleeves 5 and/or the guide sleeve 7 by vulcanisation.

The anchoring of the bearing structure is made in such a manner that when viewing FIG. 3 horizontally acting forces, i. e. forces in the x and y direction may be accommodated, while no forces are transmitted in the vertical, i. e. in the z direction.

The detail illustration in FIG. 1 shows an arc-shaped transition area between the damping material 4 and the inner wall of the pot-shaped first bearing part 6 for the purpose of improving adhesion and for the reliable diversion of occurring forces without the damping material vulcanised thereon being removed from the metallic surface.

By choosing other cross-sectional areas than a circular shape of the pot and the reinforcing sleeves S it is possible to specify different damping or stiffness ratios in the x or y direction.

According to the embodiment the damping material consists of natural or synthetic high polymers, with the pot, the reinforcing and the guide sleeves consisting of steel. In order to improve the adhesion of the damping material the corresponding surfaces of the metallic parts may have a roughened structure.

The bearing structure according to the embodiment enables a continuous force transmission with a progressive force, deformation, and stiffness distribution. The required stiffness and load bearing capacity are adjustable by simply varying the dimension ratios. Compared to rigid fastening means forces occurring due to movements of the building may be reduced when employing the bearing structure.

A special field of application for the bearing structure is its employment in earth quake protection for bridges or its employment as a floating low vibration bearing of bridge buildings, respectively.

1. A bearing structure for the damped transmission of impact and/or vibratory forces, in particular for buildings which are subjected to a seismic load, comprising a volume-elastic damping material which is arranged between two parts of a bearing body, with the first bearing part having essentially the shape of a pot, with a guide sleeve being arranged in the centre of the pot and one of several reinforcing sleeves being arranged between the guide sleeve and the pot inner wall and the damping material filling the spaces between the pot inner wall, reinforcing and guide sleeves at least partially, with the second bearing part comprising a bolt which can be displaced inside the guide sleeve, with the bolt being connected with a first fastening plate, further a second fastening plate being provided on the outside of the pot in order to anchor the first and the second bearing part, the first and the second fastening plate or fastening area being anchored or embedded, on the one hand, at the abutment, pillar, or foundation of the component to be supported and, on the other hand, on the component to be supported itself, with anchoring being effected in such a manner that horizontally, i.e. in the x and y direction, acting forces are accommodated, but no forces are transmitted vertically, i.e. in the z direction, the reinforcing sleeves being arranged concentrically about the guide sleeve and embedded in the damping material and comprising a chamfer or arc-shaped curvature at their narrow sides each, and wherein the damping material in the marginal transition areas between damping material and the pot inner wall and/or the outer wall of the guide sleeve is formed to be cambered relative to the average thickness distribution in the unloaded condition and vulcanised thereon in order to improve adhesion and force accommodation.

2. The bearing structure according to claim 1, wherein the reinforcing sleeves are adapted to the cross-sectional shape of the pot.

3. The bearing structure according to claim 2, wherein the pot comprises a circular, elliptic, rectangular, or polygonal cross-sectional area.

4. The bearing structure according to claim 1, wherein the covering and bottom areas of the pot are open and comprise such a cover or bottom area that the damping material upon deformation is able to expand essentially perpendicularly to the direction of the action of the force.

5. The bearing structure according to claim 1, wherein the damping material is joined with the pot inner wall, the outer wall of the guide sleeve and/or the reinforcing sleeves by vulcanisation thereon.

6. The bearing structure according to claim 1, wherein with an elliptic cross-sectional area of the pot and the reinforcing sleeves, different damping and stiffness values between the major and minor axis of the ellipse may be specified.

7. The bearing structure according to claim 1, wherein the formation of a continuous transition of the damping material with preferably circular arc-shaped of bead-type gradient.

8. The bearing structure according to claim 1, wherein with a rectangular cross-sectional area a·b of the pot, different damping or stiffness ratios in the direction of the respective edges a and b may be specified.

9. The bearing structure according to claim 1, wherein natural or synthetic high polymers as the damping material, with the pot, the reinforcing and the guide sleeves consisting metal, in particular of steel.

10. The bearing structure according to claim 9, wherein the metallic surfaces to be connected by vulcanisation comprise a roughened structure.

11. The bearing structure according to claim 1, wherein the bolt is rotatably supported in the guide sleeve.
